(19) United States
(12) Patent Application Publication
(10) Pub. No.: US 2017/0181423 A1
(43) Pub. Date: Jun. 29, 2017

(54) Waterfowl Trapping Device

(71) Applicant: Yuyao Liyou Plastic Daily Art Crafts Factory, Ningbo City (CN)

(72) Inventors: LIHUO XU, Yuyao City Zhejiang Province (CN); SHENG ZHOU, Auckland (NZ)

(21) Appl. No.: 14/980,355

(22) Filed: Dec. 28, 2015

(51) Int. Cl. A01M 31/06; A01M 99/00

(52) U.S. Cl. CPC A01M 31/06; A01M 99/00; A01M 2200/00

(57) ABSTRACT

The present invention discloses a waterfowl trapping device, comprising a trapping base and a trapping main body, wherein the trapping base comprises an upper seat and a lower seat, and the exterior of the trapping base is connected with a floating device; spread trapping wings are arranged on two sides of the trapping main body; a battery, a controller, a water pump and a deceleration motor which are electrically connected with each other are arranged in the trapping base; a switch is arranged between the battery and the controller; a plurality of nozzles are arranged outside the trapping base, and the nozzles are connected with the water pump by pipes; the floating device is composed of floating balls installed by a plurality of floating cross rods; and the present invention is practical, low in production cost and vivid in trapping when floating on water; and can be folded in nonuse.

### FIELD OF THE INVENTION

The present invention relates to a trapping device used on water, and particularly relates to a waterfowl trapping device.

### BACKGROUND OF THE INVENTION

Some animals on the water surface, which live in water for a long time, may pollute the water source and eat some organisms in the water. Thus, the animals on water, namely waterfowl, often need to be expelled or trapped.

The existing expelling or trapping device is simple in structure, lagged in technology and poor in expelling or trapping effect. Wings of the existing device are mostly in a rotating manner, and are greatly different from those of a real waterfowl in the motion manner. However, a small part of the existing devices capable of flapping wings do not have a water spraying function.

### SUMMARY OF THE INVENTION

The technical problem to be solved by the present invention is to provide a waterfowl trapping device capable of flapping wings and spraying water for overcoming the defects of the prior art.

To achieve the above purpose, the present invention adopts the following measures:

A waterfowl trapping device includes a trapping base and a trapping main body, wherein the trapping base includes an upper seat and a lower seat, and the exterior of the trapping base is connected with a floating device; spread trapping wings are arranged on two sides of the trapping main body; a battery, a controller, a water pump and a deceleration motor which are electrically connected with each other are arranged in the trapping base; a switch is arranged between the battery and the controller; the controller controls the pumping of the water pump and the rotation of the deceleration motor; a plurality of nozzles are arranged outside the trapping base, and the nozzles are connected with the water pump by pipes; two turntables are arranged on an output shaft of the deceleration motor, each turntable is connected to a trapping wing by a connecting rod, the deceleration motor drives the trapping wings to flap, and meanwhile, water pumped by the water pump is sprayed to the middle positions of the flapping trapping wings by the nozzles;

the floating device is composes of floating balls installed by a plurality of floating cross rods;

the floating cross rods are foldable aluminum rods;

the battery is connected with a recharge socket;

the trapping main body is of a duck or goose model;

a remote control receiver and a timer are arranged in the controller, and the remote control receiver is configured with a remote control transmitter;

two nozzles are arranged, and the spray heads of the nozzles are bent for a certain angle;

the bent spray heads of the two nozzles respectively face the central positions of the spread trapping wings on the two sides;

the pipes are PVC (polyvinyl chloride) hoses, the turntables are bonded onto the output shaft of the deceleration motor through glue, and the two ends of the connecting rods are respectively fixed on the trapping wings and the turntables through rivets;

four floating cross rods are provided and arranged in a cross shape, and each floating cross rod is sleeved with two floating balls.

The present invention has the beneficial effects that the waterfowl trapping device is practical, convenient to use, safe, low in production cost and vivid in trapping when floating on water, has a good trapping effect, and can be folded in nonuse so as to occupy a small space.

### BRIEF DESCRIPTION OF THE DRAWINGS

FIG. 1 is a schematic diagram of an external structure of the present invention.

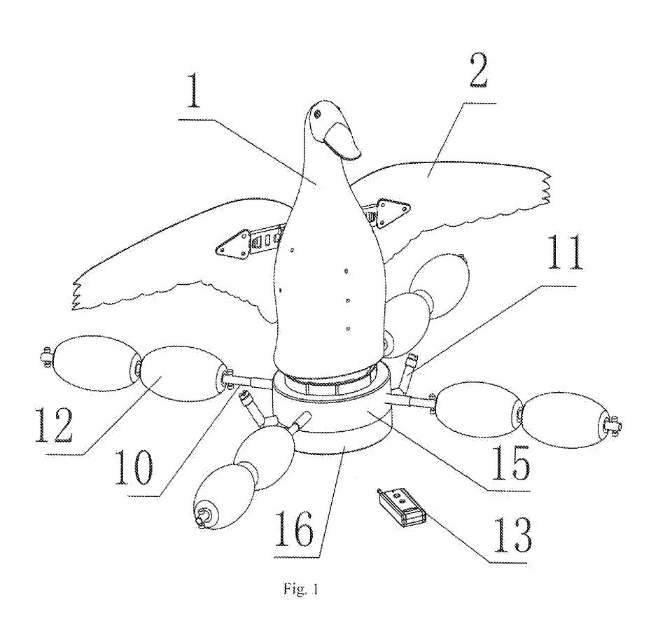

FIG. 2 is a schematic diagram of a breakdown structure of the present invention.

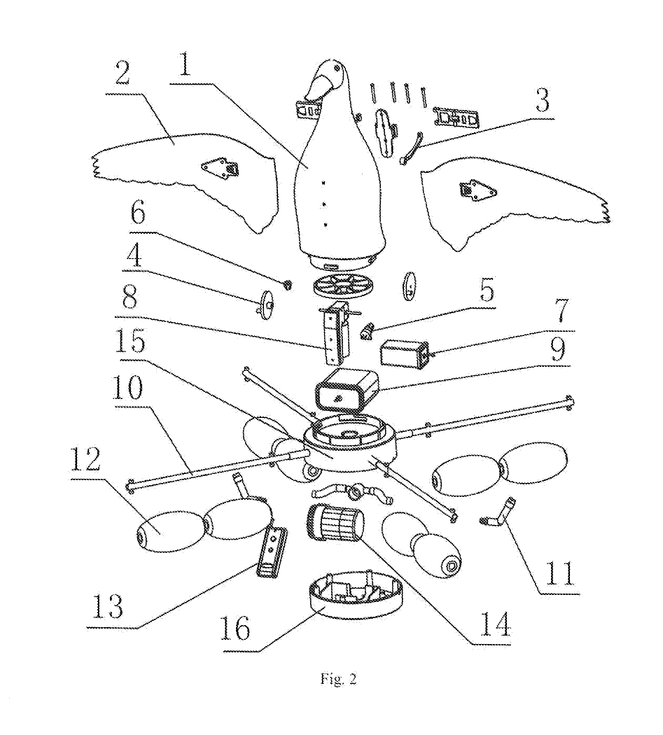

### DETAILED DESCRIPTION OF THE EMBODIMENTS

A waterfowl trapping device includes a trapping base and a trapping main body 1, wherein the trapping base includes an upper seat 15 and a lower seat 16, and the exterior of the trapping base is connected with a floating device; spread trapping wings 2 are arranged on two sides of the trapping main body 1; a battery 9, a controller 7, a water pump 14 and a deceleration motor 8 which are electrically connected with each other and arranged in the trapping base; a switch 5 is arranged between the battery 9 and the controller 7; the controller 7 controls the pumping of the water pump 14 and the rotation of the deceleration motor 8; a plurality of nozzles 11 are arranged outside the trapping base, and the nozzles 11 are connected with the water pump 14 by pipes; two turntables 4 are arranged on an output shaft of the deceleration motor 8, each turntable 4 is connected to a trapping wing 2 by a connecting rod 3, the deceleration motor 8 drives the trapping wings 2 to flap, and meanwhile, the water pumped by the water pump 14 is sprayed to the middle positions of the flapping trapping wings 2 by the nozzles 11. The two sides of the trapping wings 2 are printed with feather patterns on the two sides of wings of a real waterfowl in a high definition manner, thus nearly achieving a real effect. A plug-in connection structure is adopted between the trapping wings 2 and the trapping main body 1, to facilitate detachment.

The floating device is composed of floating balls 12 installed by a plurality of floating cross rods 10.

The waterfowl trapping device is placed on water, e.g., on a lake. The overall waterfowl trapping device floats on the water by means of the floating device (buoyancy of the floating balls 12). The switch 5 controls the on and off of a power supply, the controller 7 controls the pumping of the water pump 14 and the rotation of the deceleration motor 8, the rotation of the deceleration motor 8 drives the turntables 4 to rotate, the turntables 4 drive the trapping wings 2 through the connecting rods 3 to continuously flap, the water pump 14 pumps water, and the nozzles 11 drain the water. The overall device flaps wings on the water like the trapping main body 1, such as a duck, a goose or other waterfowl. The device is vivid, and can well attract waterfowl on the water to fulfill the purpose of trapping. The device perfectly simulates the effect of water splashing when the waterfowl plays with water and the wings flap the water.

The floating cross rods 10 are foldable aluminum rods. The folded aluminum rods can be collected in nonuse to reduce the volume of the whole device.

The battery 9 is connected with a recharge socket 6, so the device can be charged and is convenient to use.

The trapping main body 1 is of a duck or goose model.

A remote control receiver and a timer are arranged in the controller 7, and the remote control receiver is configured with a remote control transmitter 13. The remote control transmitter 13 controls the whole device, so the device is more convenient to operate. The working time of the whole device can be controlled by the timer.

The timer can be set to turn on for 2 seconds and turn off for 5 seconds, turn on for 5 seconds and turn off for 10 seconds, so that the device can perfectly simulate the real flapping rhythm of the waterfowl.

Two nozzles 11 are arranged, and the spray heads of the nozzles 11 are bent for a certain angle.

The bent spray heads of the two nozzles 11 respectively face the central positions of the spread trapping wings 2 on the two sides. After water is pumped, the water is sprayed onto the trapping wings 2 by the nozzles 11, to produce an effect more approaching the water flapping effect of the wings of the waterfowl.

The pipes are PVC hoses, the turntables 4 are bonded onto the output shaft of the deceleration motor 8 through glue, and the two ends of the connecting rods 3 are respectively fixed on the trapping wings 2 and the turntables 4 through rivets.

Four floating cross rods 10 are provided and arranged in a cross shape, and each floating cross rod 10 is sleeved with two floating balls 12. Thus, the device floats more stably.

The actions that wings of a waterfowl flap water to splash the water as well as the waterfowl takes off and lands on the water and plays with the water are natural and common actions of the waterfowl. The effects that the waterfowl flaps the wings and the wings flap water are perfectly designed on the same trapping device. Therefore, the device is vivid in trapping and good in trapping effect.

1. A waterfowl trapping device, comprising a trapping base and a trapping main body (1), wherein the trapping base comprises an upper seat (15) and a lower seat (16), and the exterior of the trapping base is connected with a floating device; spread trapping wings (2) are arranged on two sides of the trapping main body (1); a battery (9), a controller (7), a water pump (14) and a deceleration motor (8) which are electrically connected with each other are arranged in the trapping base; a switch (5) is arranged between the battery (9) and the controller (7); the controller (7) controls the pumping of the water pump (14) and the rotation of the deceleration motor (8); two nozzles (11) are arranged outside the trapping base, and the nozzles (11) are connected with the water pump (14) by pipes; two turntables (4) are arranged on an output shaft of the deceleration motor (8), each turntable (4) is connected to a trapping wing (2) by a connecting rod (3), the deceleration motor (8) drives the trapping wings (2) to flap, and meanwhile, water pumped by the water pump (14) is sprayed to the middle positions of the flapping trapping wings (2) by the nozzles (11).

2. The waterfowl trapping device of claim 1, wherein the floating device is composed of floating balls (12) installed by a plurality of floating cross rods (10).

3. The waterfowl trapping device of claim 1 or 2, wherein the battery (9) is connected with a recharge socket (6).

4. The waterfowl trapping device of claim 3, wherein the trapping main body (1) is of a duck or goose model.

5. The waterfowl trapping device of claim 4, wherein a remote control receiver and a timer are arranged in the controller (7), and the remote control receiver is configured with a remote control transmitter (13).

6. The waterfowl trapping device of claim 5, wherein bent spray heads of the two nozzles (11) respectively face the central positions of the spread trapping wings (2) on the two sides.
